(19) United States
(12) Patent Application Publication
(10) Pub. No.: US 2015/0178476 A1
(43) Pub. Date: Jun. 25, 2015

(54) SYSTEM AND METHOD OF MONITORING FONT USAGE

(71) Applicant: Andrew Horton, Melbourne (AU)

(72) Inventor: Andrew Horton, Melbourne (AU)

(21) Appl. No.: 14/140,445

(22) Filed: Dec. 24, 2013

(51) Int. Cl. G06F 21/10; G06F 17/21

(52) U.S. Cl. CPC G06F 21/10; G06F 17/214

(57) ABSTRACT

A system and method of monitoring font usage is provided whereby fonts are monitored on a distributed computer network such as the Internet by searching for a font represented by a font image or font file, extracting metadata from said font image or font file to populate a font database, and using information extraction means and comparison means with information on the font database to detect and record whether usage of the font has been authorized according to the license of the copyright owner. Preferably, said comparison means are implemented by generating an image preview of an unknown font file and comparing the hash of the resulting image with hashes of images of known font files. Reports may be generated which rank infringing websites according to predetermined criteria including estimated number of downloads of restricted font files and financial status of the website owner.

### FIELD OF THE INVENTION

The present invention relates generally to a system and method of monitoring font usage.

Particularly, but not exclusively the invention relates to a system and method for monitoring usage of fonts on multimedia content, including web sites on a distributed computer network such as the Internet by searching for a font represented by a font image or font file, extracting metadata from said font image or font file to populate a font database, and using information extraction means and comparison means with information on the font database to detect and record whether usage of the font has been authorized according to the license of the copyright owner.

### BACKGROUND OF THE INVENTION

Piracy of intellectual property is a growing issue which causes significant financial losses to artists and copyright holders. The issue of piracy of intellectual property has increased exponentially since technology has become available to allow software programs to be copied with ease, for example via copying of floppy disks and CDs, and more recently peer-to-peer networks allowing the global sharing and downloading of files over the Internet. With the advent of new technologies without effective digital rights management (DRM), new opportunities for piracy become available, and technology allowing the linking of fonts over the Internet is no exception.

Web servers connected to the Internet have web pages stored therewithin. Web pages are accessible by client programs (i.e., web browsers) utilizing the Hypertext Transfer Protocol (HTTP) via a Transmission Control Protocol/Internet Protocol (TCP/IP) connection between a client-hosting device and a server-hosting device.

Web browsers typically provide a graphical user interface for retrieving and viewing information, applications and other resources hosted by Internet/intranet servers (hereinafter collectively referred to as “web servers”, “web pages” or “websites”). Web content including, but not limited to, information, applications, applets and other video and audio resources (collectively referred to herein as “files”) are conventionally delivered from a web server to a web browser on a user's computer in the form of web pages. As is known to those skilled in this art, a web page is conventionally formatted via a standard page description language such as HyperText Markup Language (HTML), and typically displays text and graphics, and can play sound, animation, and video data. HTML provides basic document formatting and allows a web content provider to specify hypertext links (typically manifested as highlighted text) to other servers and files. When a user selects a particular hypertext link, a web browser reads and interprets the address, called a Uniform Resource Locator (URL) associated with the link, connects the web browser with the web server at that address, and makes an HTTP request for the file identified in the link. The web server then sends the requested file to the client in HTML format which the browser interprets and displays to the user.

When HTML was first created, the range of fonts that could be used by a web designer for text content of a website was effectively limited to the set of fonts that could be expected to be installed on most computers viewing that website. This restricted web designers to using about a dozen fonts that were installed by default on common operating systems. Cascading Style Sheets (CSS) is a style sheet language used for describing the presentation semantics (the look and formatting) of a document written in a markup language such as HTML. Subsequent CSS specifications allowed downloading of fonts from a remote server which dramatically increased the number of fonts that a web browser could use to render text content. A technique to download remote fonts was first described in the CSS2 specification, which introduced the @font-face rule. The CSS @font-face embedding technique allows a website designer to use fonts that are not installed on the user's computer by linking to a remote server to retrieve a font file. This works with various web browsers including Internet Explorer 4+, Firefox 3.5+, Safari 3.1+, Opera 10+ and Chrome 4.0+.

The ability to link to a remote font file in a web page is controversial because this can enable font files to be freely downloaded without restriction. A font file can be saved by anyone on the Internet, then installed in an operating system and subsequently used to make multimedia content, for example to create a brochure or word processing document. Downloading and installing a font file from a web page does not require special technical knowledge and can be performed with the following steps: view a webpage's source, click on a link to a font file, download that file, then install it as a font into the operating system. TrueDoc (PFR), Embedded OpenType (EOT) and Web Open Font Format (WOFF) are font formats which incorporate digital rights management (DRM) to address these issues, however, the industry standard font formats TrueType (TTF) and OpenType (OTF) do not currently support DRM. Most commercial font foundries object to the redistribution of their fonts without DRM. However, as the majority of current web browsers support @font-face linking, and because of the lack of cross-browser support for font formats that use DRM, this has resulted in many fonts being used in breach of their license or being illegally spread through the Internet.

The advent of mechanisms such as Typekit have increased the number of fonts which can be used in web pages legally. Typekit provides a means to restrict linking to font files via @font-face embedding to licensed websites only. However, these solutions are not perfect and in the absence of industry standard DRM, there is an incentive to use fonts in an infringing manner and therefore a need for a system and method which allows the effective monitoring of infringing usage of fonts over the Internet.

### SUMMARY OF THE INVENTION

The present invention relates generally to a system and method of monitoring font usage in multimedia content.

In a first aspect the invention provides a method of monitoring font usage including the steps of:

searching multimedia content for a font represented by a font image or font file;
extracting metadata from said font image or font file to populate a database;
comparing said metadata with information within said database to identify said font.

In a second aspect the invention provides a method of monitoring font usage including the steps of:

searching the HTML and associated files of a website for a linked font file;
using identification means to identify a font from said linked font file;
extracting metadata from said linked font file to populate a database; and using information extraction means to extract a plurality of attributes from said linked font file;
using comparison means on said attributes with information in said database to detect whether usage of said font file has been authorized according to the license of a font copyright owner.

In a third aspect the invention provides a method for monitoring font usage further including the steps of:

searching the HTML files of a plurality of websites;
identifying all style content including Cascading Style Sheet (CSS) files and HTML STYLE tags;
identifying all script content including external scripts and HTML SCRIPT tags;
searching all said files, scripts and tags for the presence of an @font-face CSS declaration;
upon identifying a said @font-face CSS declaration within said website, extracting and recording the URL location of the link to the font file and downloading the font file; identifying whether said font file is already known by using comparison means to compare it to a plurality of attributes of previously recorded font files within a database;
wherein if said font file is determined as known by using comparison means then recording and updating said attributes including the time and date of the detection of link to said known font file on said web page within said database;
wherein if said font file is determined as unknown by using comparison means then recording it as a newly identified font file and using information extraction means including comparison with known keywords to extract a plurality of attributes from metadata of said newly identified font file including the font name, the font copyright owner, font license information, and whether said font license permits linking using said @font-face CSS declaration, and recording said attributes and the time and date of the detection of link to said newly identified font file on said web page within said Font Database.

In a fourth aspect the invention provides a computer program for instructing a computer to perform a method of monitoring font usage including the steps of:

searching the HTML files of a plurality of websites;
identifying all style content including Cascading Style Sheet (CSS) files and HTML STYLE tags;
identifying all script content including external scripts and HTML SCRIPT tags;
searching all said files, scripts and tags for the presence of an @font-face CSS declaration;
upon identifying a said @font-face CSS declaration within said website, extracting and recording the URL location of the link to the font file and downloading the font file;
identifying whether said font file is already known by using comparison means to compare it to a plurality of attributes of previously recorded font files within a database;
wherein if said font file is determined as known by using comparison means then recording and updating said attributes including the time and date of the detection of link to said known font file on said web page within said database; wherein if said font file is determined as unknown by using comparison means then recording it as a newly identified font file and using information extraction means including comparison with known keywords to extract a plurality of attributes from metadata of said newly identified font file including the font name, the font copyright owner, font license information, and whether said font license permits linking using said @font-face CSS declaration, and recording said attributes and the time and date of the detection of link to said newly identified font file on said web page within said database.

In a fifth aspect the invention provides a system of monitoring fonts comprising:

a scanner configured to scan the HTML files of a plurality of websites;
identifying all style content including Cascading Style Sheet (CSS) files and HTML STYLE tags;
identifying all script content including external scripts and HTML SCRIPT tags;
searching all said files, scripts and tags for the presence of an @font-face CSS declaration; and upon identifying a said @font-face CSS declaration within said website,
extract and record the URI location of the font file;
a database configured to record a plurality of attributes related to a plurality of font files and their use on a plurality of websites;
an analyser configured to download the font file; identify whether said font file is already known by using comparison means to compare it with a plurality of attributes of previously recorded font files within said database;
wherein if said font file is determined as known by using comparison means then recording and updating said attributes including the time and date of the detection of link to said known font file on said web page within said database;
wherein if said font file is determined as unknown by using comparison means then recording it as a newly identified font file and using information extraction means including comparison with known keywords to extract and record a plurality of attributes from metadata of said newly identified font file including the font name, the font copyright owner, font license information, and whether said font license permits linking using said @font-face CSS declaration, and recording said attributes and time and date of the detection of link to said newly identified font file on said web page within said database.

Preferably, the searching of websites is implemented by said scanner using Hypertext Transfer Protocol (HTTP) and Hypertext Transfer Protocol Secure (HTTPS).

Preferably, said information extraction means uses comparisons with known keywords to extract said attributes from said metadata of said font files.

Preferably, said comparison means are implemented by using a hash of said unknown font file to determine whether it is the same as the hash of a said known font file.

Alternatively, said comparison means are implemented by generating an image preview of an unknown font file and comparing the hash of the resulting image with hashes of images of known font files, and where the hashes of images are identical then identifying said unknown font file as said known font file having the identical hash.

Alternatively, said comparison means are implemented using a dissimilarity algorithm including using the normalized root mean squared method to compare said image preview of an unknown font file with images of said known font files and where a known image is similar to said image preview within a predetermined threshold value, then identifying said unknown font file as said known font file having a similar known image.

Preferably, said linking to said font file using said @font-face CSS declaration is identified and recorded as restricted or unrestricted within said Font Database using License Recognizer means including determining whether said plurality of attributes extracted from metadata contain features such as keywords or data indicative of a restricted or unrestricted license for that particular font file.

Preferably, additional attributes of said websites are recorded at time and date of the detection of link to said known or newly identified font file, including an estimate of the number of downloads of said font file based on an estimate of website views, and the identity and financial status of the website owner by using independent website ranking statistics, WHOIS registration information, and keyword searches.

Preferably, said database is remotely accessible over the Internet and said attributes of fonts recorded in said database are searchable by a user.

Preferably, said database is configured to generate reports including websites ranked according the estimated number of downloads of restricted font files, time and date of such downloads, and financial status of the website owner, and can be configured to restrict information regarding fonts to a user, for example to restrict disclose of information to a user to information about fonts which belong to a single, font foundry or intellectual property owner.

Preferably, a user will be able to generate said reports according to predetermined criteria.

Preferably, said websites ranked on said reports are compared to a known list of websites having authorized license holders wherein if said website owner of said website is an authorized license holder and the number of downloads is permitted according to the font license of the font copyright owner (or their assignees) then said website is removed from said automatic report or alternatively acknowledged as operating within the terms of an authorized license.

More specific features for preferred embodiments are set out in the description below.

### OBJECTS OF THE INVENTION

It is an object of the present invention to provide a system and method for monitoring usage of fonts on a distributed computer network such as the Internet.

It is a further object of the present invention to provide a system and method for identifying @font-face linked fonts on websites, and extracting metadata from said @font-face linked font file to populate a database.

It is a further object of the present invention to provide a system and method for detecting a font copyright owner and whether usage of a font has been authorized according to the license of the copyright owner.

It is a further object of the present invention to provide a system and method to generate reports including websites ranked according the estimated number of downloads of restricted font files, time and date of such downloads, and financial status of the website owner.

Further objects and advantages of the present invention will be disclosed and become apparent from the following description. Each object is to be read disjunctively with the object of at least providing the public with a useful choice.

### BRIEF DESCRIPTION OF THE DRAWINGS

FIG. 1 is a block diagram illustrating a preferred embodiment of the invention.

FIG. 2 is an example of HTML within a web page which includes style content that contains multiple @font-face declarations.

FIG. 3 is a flow chart showing the preferred embodiment of how the Scanner scans HTML within a web page to detect and record a list of links using the CSS @font-face declaration.

FIG. 4 is a flow chart showing the preferred embodiment of how the font Analyzer downloads, extracts, identifies and records the font file metadata on the Font Database.

FIG. 5 is a flow chart showing the preferred embodiment of how the Font Identifier compares font files font images in order to identify whether a font file is known within the Font Database.

FIG. 6 is a flow chart showing the preferred embodiment of how the License Recognizer detects whether usage of the font file is restricted or unrestricted.

FIG. 7 is a flow chart showing the preferred embodiment of how the Foundry Recognizer determines who is the copyright holder of the font.

FIG. 8 is a schematic showing the preferred embodiment of the model for the Font Database.

FIG. 9 is a screen shot of the preferred embodiment of the graphical user interface of the Font Database.

FIG. 10 is a flow chart showing the preferred embodiment of how the Report Generator creates reports of potential infringements.

FIG. 11 is a flow chart showing an alternative embodiment of how the font Analyzer downloads, extracts, identifies and records the font image metadata from multimedia content in the Font Database.

FIG. 12 is a flow chart showing an alternative embodiment of how the Scanner 100 extracts and Font Identifier 108 compare font files font images extracted from multimedia content in order to identify whether a font file is known within the Font Database.

### DETAILED DESCRIPTION OF THE INVENTION

Various embodiments of the present invention are described hereinafter with reference to the figures. It should be noted that the figures are only intended to facilitate the description of specific embodiments of the invention. In addition, an aspect described in conjunction with a particular embodiment of the present invention is not necessarily limited to that embodiment and can be practised in any other embodiments of the present invention.

In this specification, the term “keyword” or “keywords” will be used to refer to any data signature or data signatures which further may include text strings or regular expressions, and the scope of the expression “keyword” or “keywords” should not be restricted accordingly.

In this specification, the term “metadata” will be used to refer to any useful data/information (for example, font attributes such as font image (including the 2-D shape of the font), name of the font, font owner, license information, time/date, location of font, URI, etc.) that can be extracted from or associated with existing data/information (for example, known font files, font images or website HTML or multimedia content or related information such as instances of use of font). In accordance with the preferred embodiment, the term metadata refers to information extracted from the NAME table of a font file (e.g. name of the font, font owner, license URL etc.), however usage of the term should not be restricted in this manner.

Generally, the invention relates to a system and method of monitoring font usage over the Internet. More particularly, the invention relates to a system and method for monitoring usage of fonts on a distributed computer network such as the Internet by searching a web page's HTML for the CSS @font-face embedding technique, extracting metadata from the linked font to populate a Font Database, and using information extraction means and comparison means with information on the Font Database to identify the font. Preferably the system will detect whether usage of the font has been authorized according to the license of the copyright owner. Preferably, the system and method is implemented by a software program run on a computer having standard operating system (e.g. Windows, Mac OS/X, Linux) and a web browser (e.g. Mozilla, Chrome, Internet Explorer, Safari, Opera) which is connected to the Internet, and access to a data storage device having non-volatile memory. Preferably, a user would have access to such a computer implementing the invention, either via the Internet or via a human interface device (e.g. mouse/keyboard). Preferably, the software program is a web application written in the Ruby on Rails programming language although it will be apparent to those skilled in the art that other programming languages may be used (e.g. Java, C, C++, C#, Perl, JavaScript, Visual Basic .NET, PHP, Ajax, Python) to implement the invention. Although specific ‘modules’ are disclosed comprising the ‘system’ in this specification (e.g. Scanner, Analyzer, Font Identifier, License Recognizer, Foundry Recognizer, Report Generator etc) these are merely labels of convenience to exemplify the implementation of the invention described herein (preferably, by running a software program on a computer processor) and that all, some, or none such modules may be used, and that different labels may be provided to them, although this will not change the operation of the invention. For example, another module or modules may perform the steps stated herein to be performed by a particular ‘module’. Alternatively, all the various modules may be collated and the steps to be performed by them can be performed by a single computer processor (apart from steps for which human input is contemplated in this specification e.g. manual identification of fonts and font attributes such as font license details or input of preferred criteria for generating list of websites or infringement reports).

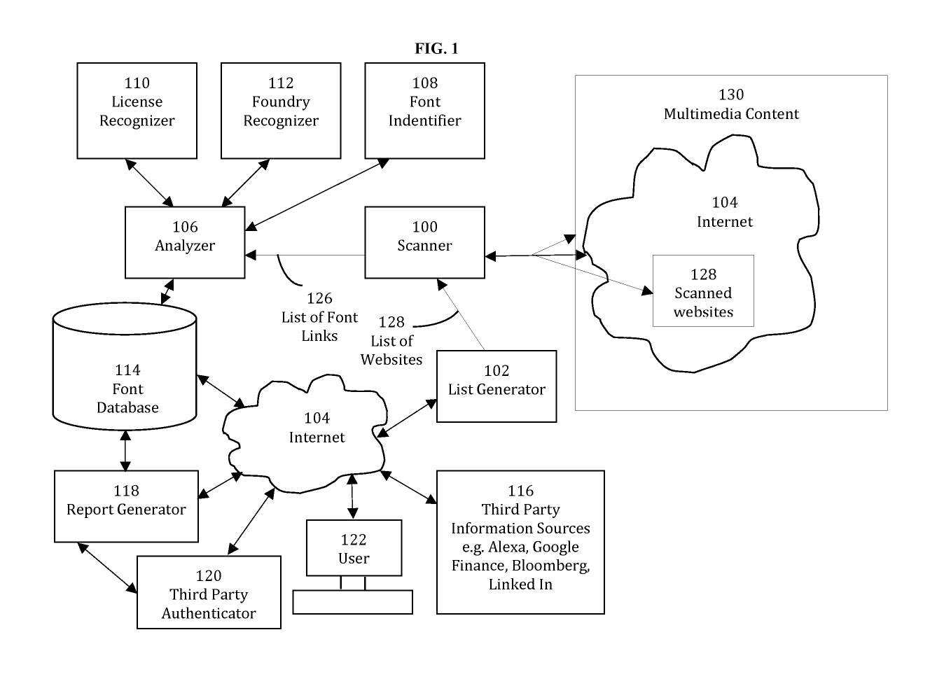

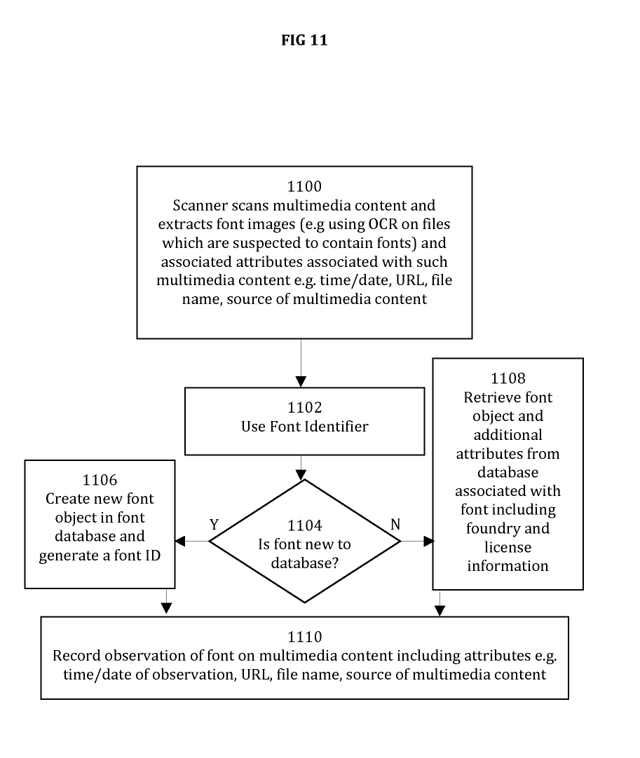

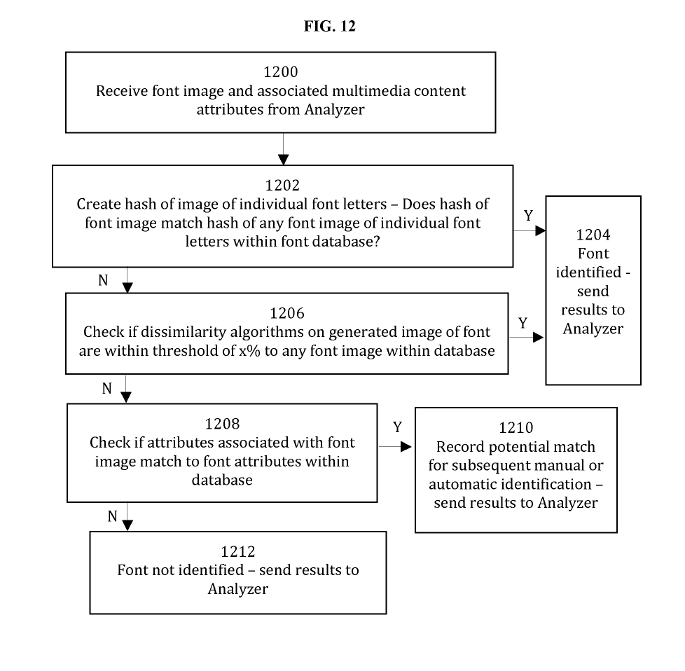

Referring to the various components of the preferred embodiment of the invention, FIG. 1 shows a Scanner 100 which is configured to scan the Internet 104, preferably using the HTTP and/or HTTPS protocol. In an alternative embodiment, the Scanner 100, Analyzer 106 and Font Identifier 108 is configured to scan and identify multimedia content for font images which includes the Internet, digital files (such as PDFs), and printed and digital media generally, in a manner described with reference to FIG. 11 and FIG. 12 below. A list generator 102 can generate a list of websites 128 to be scanned by the Scanner 100 which are ranked according to certain criteria that may be useful to a font copyright owner or their legal advisors. This information can be automatically and/or manually obtained and ranked by the list generator 102, for example, by using software to search and extract information from various third party information sources 116 over the Internet 104. Such third party information sources 116 can be websites or services that provide information regarding the popularity or number of hits for the website (e.g. individual browser requests to download data from the webserver) such as www.alexa.com, and/or websites or services that provide information regarding the identity of the website owner (such as registration information extracted from the WHOIS databases) and financial status of website owners (such as market capitalization, financial performance or employee size information which can be extracted from websites such as www.google.com/finance, www.bloomberg.com, or www.linkedin.com). Other public information sources (such as Google search or Wikipedia) or private information sources may be used, and it will be apparent to those skilled in the art that the process by which the list generator 102 may create a list of websites 128 may be partially automated and/or require manual input by a user 112 (e.g. providing criteria such as keywords, number of employees, value of market capitalization, geographical location, etc.) Ideally, the invention will be configured to find instances of potential font infringement while reducing the amount of false positives and without missing instances of potential infringement. Preferably, the list of websites 128 is created using the current top Alexa rankings and the Scanner 100 may scan more or fewer websites according to the maximum server bandwidth/data transfer available to a user. By way of example, the top ranked 1,000,000 websites on www.alexa.com may be included in the list of websites 128 to be scanned by the Scanner 100. The Scanner 100 is configured to scan the HTML of the list of websites 128 provided by the list generator 102 and the Scanner 100 creates a list of font links 126 (preferably, @font-face declaration links) which are sent to the font Analyzer 106. Alternatively, as mentioned below in FIG. 11, the Scanner 100 can be configured to scan multimedia content 130 to extract font images which are subsequently analysed. The font Analyzer 106 is configured to download the font files from the list of font links 126 and to extract and analyze metadata from the font files. The font Analyzer 106 also uses the Font Identifier 108, License Recognizer 110, and Foundry Recognizer 112 on the content of the font files to identify fonts, font copyright owners (i.e foundries) and vet their licenses to determine whether downloading of fonts is restricted or unrestricted and to generate font attributes to populate the Font Database 114 with information. Preferably, the Font Database 114 is configured to allow a facility for foundries to upload their own font information. This can be used to form the set of fonts to be tracked/subscribed to and for comparison purposes. The Report Generator 118 is configured to create reports regarding potentially infringing use of restricted fonts on websites using information stored in the Font Database 114. Preferably, the potential infringers named in such reports are ranked according to the criteria used to ranking the list of websites 128 using third party information sources 116 as well as information stored in the Font Database 114. Preferably, the information in such reports is authenticated by a Third Party Authenticator 120, which, by way of example, may include a provider of digital certificates for time/date stamping of documents e.g. www.digistamp.com, or may be implemented by sending information to a reliable third party server which records the date such information is received e.g. sending emails of reports to a Gmail account. As discussed, such Third Party Authenticator 120 may authenticate the time and date of creation of the reports themselves but may also authenticate the source of information on those documents i.e. the content of websites of potential infringers, for example, by independently downloading data from websites of potential infringers, such as copies of the HTML, images of webpages, and/or downloading the font files linked via @font-face declarations. Such time/date and source authentication may occur at other times, such as the time of entry of attributes into the Font Database 114. Other methods to provide time/date and source authentication of documents will be readily apparent to those skilled in the art.

For avoidance of doubt, any of the steps undertaken by components of the invention as described in FIG. 1 and in this specification can be undertaken manually by a user 122, although it is preferred if such steps can be automated to the maximum extent possible. The invention can be configured to alert a user 122 where human input may be required (e.g. where the Font Identifier 108, License Recognizer 110 or Foundry Recognizer 112 fail to work or if there is a conflict between keywords which cannot be resolved by application of the predetermined rules or algorithm). Until it is manually updated, font information will be recorded as unknown if it cannot be automatically determined.

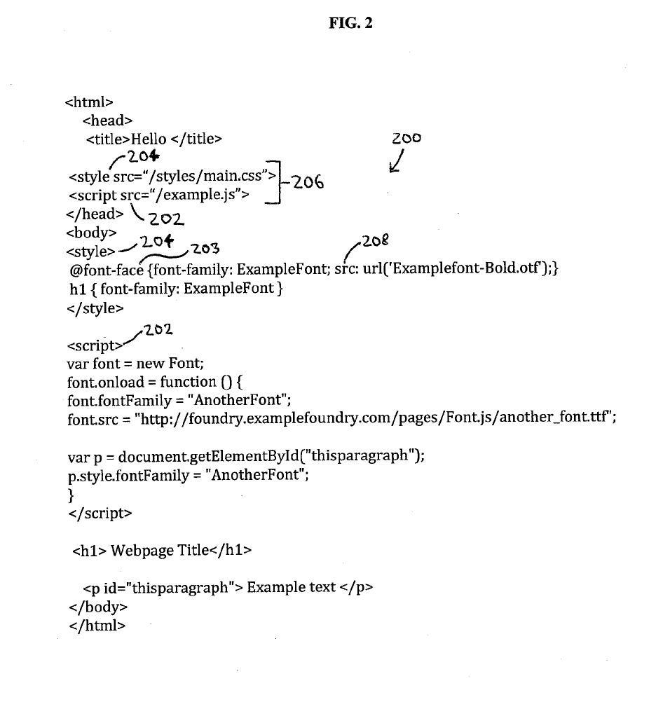

FIG. 2. shows an example of HTML 200 which can be scanned by the Scanner 100. The HTML 200 demonstrates how fonts can be defined within JavaScript using <script> tags 202 and also using Cascading Style Sheets (CSS) which use <style> tags 204. Both <script> and <style> tags can have their content within the opening and closing tags, or the content can be contained in another file which is referenced by using the HTML tag parameter, “src” 206.

The Scanner 100 can detect an @font-face declaration 203 within <style> tags 204 including any referenced src files. The Scanner 100 will automatically retrieve any referenced src files, in a recursive manner, in order to detect font references. An @font-face declaration can contain a link to the source file of a font 208 in a similar way to how <script> and <style> tags reference source files.

The Scanner 100 can detect references to fonts in <script> tags including any referenced src files by searching for the text string, “font”. If this is identified within a file then any text strings that contain a font format suffix, e.g. “.ttf” and “.otf” will be identified as possible filenames for fonts. The preferred method to resolve the URL of these font files is to predict locations based on its location relative to the file it is referenced in, and then test those locations. This testing process will attempt URL paths between the root of the website, and the full path of the file that references font filenames.

For example, if JavaScript content contains the test string “font” and the text string “curly-font.ttf”, and the JavaScript source file is “http://www.example.com/scripts/thisfont.js”, then the set of predicted URLs to ‘test’ for the location of a font file is:

www.example.com/scripts/curly-font.ttf;
www.example.com/curly-font.ttf; or
www.example.com/fonts/curly-font.ttf

If the text string “font” is found within JavaScript of the website 202 but no font file is discovered, a record of the website is logged for manual inspection. An alternative method is to use a web browser and monitor the URI locations the website attempts to access. It should be noted that this may be a headless browser, which is a web browser without a GUI that can be configured to run a program automatically, and are commonly used in web development testing.

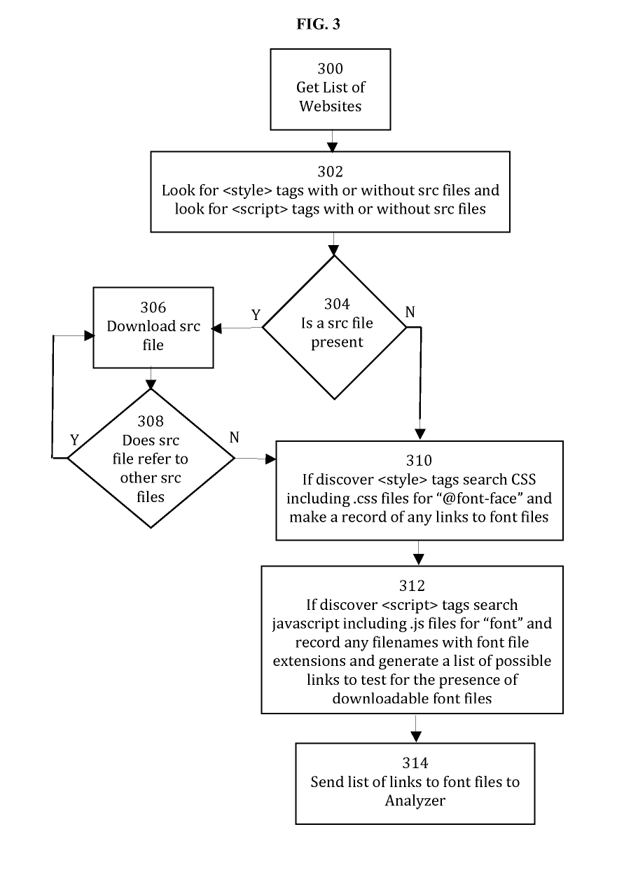

FIG. 3 is a flow chart showing the preferred embodiment of how the Scanner scans HTML within a webpage to detect and record a list of links using the CSS @font-face declaration. In step 300 the Scanner gets a list of websites 128. In step 302, the Scanner makes a list of style locations by firstly searching the HTML of the websites for <style> tags with or without src files and <script> tags with or without src files. In step 304 the Scanner determines if there is a src file and if so, at step 306 it downloads the file. At step 308, if the downloaded src file refers to other src files (i.e. nested files) it returns to step 306 and downloads that file. At step 310, if any @font-face declarations are found, the Scanner will search for “@font-face” in the found locations and make a record of any links to any font files discovered. Step 310 is of use when searching CSS files rather than javascript. At step 312, the Scanner will search within <script> HTML or javascript files for the text “font” and record the presence of any file names with font file extensions (e.g. ExampleFont.otf, ExampleFont.ttf) and generate a list of possible links to ‘test’ for the presence of downloadable font files. At step 314, the Scanner will send a list of font links 126 linking to font files to the Analyzer 106.

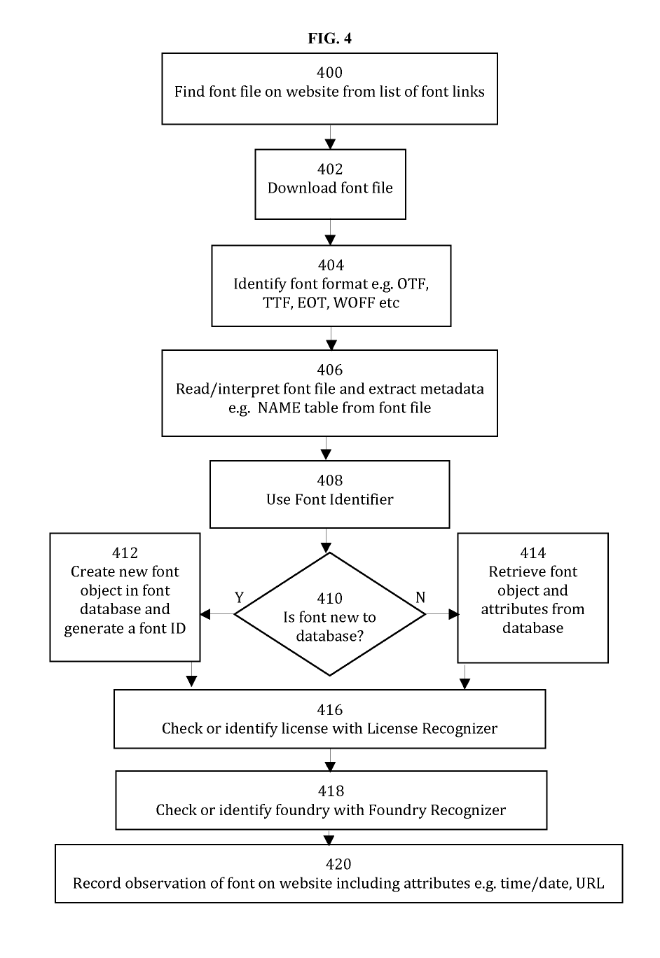

FIG. 4 is a flow chart showing the preferred embodiment of how the font Analyzer 106 downloads, extracts, identifies and records the font file metadata on the Font Database. In step 400 the font Analyzer finds the location of the font file on from the list of font links 126 and at step 402 it downloads the font file. At step 404 the font Analyzer identifies the format of the font file (e.g. .otf, .eot, .ttf, .woff etc) and at step 406 it reads or interprets the file and extracts useful metadata which can be recorded as font attributes. OpenType fonts may have the extension .OTF or .TTF, depending on the kind of outlines in the font and the creator's desire for compatibility on systems without native OpenType support. The preferred embodiment of the invention currently downloads only OpenType fonts as these file types do not currently support DRM and therefore use of OpenType fonts having a restricted license is more likely to be infringing use. An OpenType font file contains data, in table format, that comprises either a TrueType or a PostScript outline font. Rasterizers use combinations of data from the tables contained in the font to render the TrueType or PostScript glyph outlines. In the current specification, useful metadata is contained and extracted from the “name table” of the font file (also known as the “naming table”), which allows multilingual strings to be associated with the OpenType font file. These strings can represent copyright notices, font names, family names, style names etc, which can be useful attributes to populate the Font Database 114.

An example of some font attributes which can be extracted from the name table of files using the OpenType specification is provided in Table 1 below:

TABLE 1
uniqueid=ExampleFont-Bold: 2012
postscript=ExampleFont-Bold
license=SIL Open Font License, Version 1.1
designer=John Smith
fullname=John Smith Bold
vender url=http://examplefoundry.com/typedesign/
designer url=http://examplefoundry.com/typedesign/
manufacturer=Example Foundry
version=Version 1.002
family=Example Font
compatible full=Example Font Bold
copyright=Copyright (c) 2012
(http://examplefoundry.com/typedesign/)
All rights reserved.\hat{ }JThis Font Software is licensed
under the SIL Open Font License, Version
1.1.\hat{ }JThis license is available with a FAQ at:
http://scripts.sil.org/OFL
descriptor=Example Font was first published in 2004 and is John's
first ever finished typeface. Its Bold is reminiscent of 1960s acid
house typography, while the rather thin fonts bridge the
gap to present times. Lacking self confidence and knowledge about the
type scene John decided to publish the family for free under a Creative
Commons License.
subfamily=Bold
license url=http://scripts.sil.org/OFL
trademark=John Smith is a trademark of Example Foundry

It is well known to those skilled in the art that there are various software programs freely available that can read or interpret a font file (and other types of font file other than OpenType), in particular, useful metadata associated with that font file. For example, there are various application programming interfaces (APIs) or libraries that can be used to work with font files such as Robofab for Python (see http://www.robofab.org, which is incorporated by reference herein). Most font editors, many of which are available for free, can be used to view font metadata such as the name table section of a font file (e.g. see http://www.high-logic.com/font-editor/fontcreator.html or http://fontforge.sourceforg.net/, which is incorporated by reference herein). Alternatively, many operating systems provide font information about font files. For example, Windows XP and 7 provide a font properties dialog box in Windows Explorer. This can be used to view and extract information from the name section. For example, this can be done manually by right clicking on a font file in the windows\fonts\ folder then going to the Details tab, which has a link named ‘Remove Properties and Personal Information’.

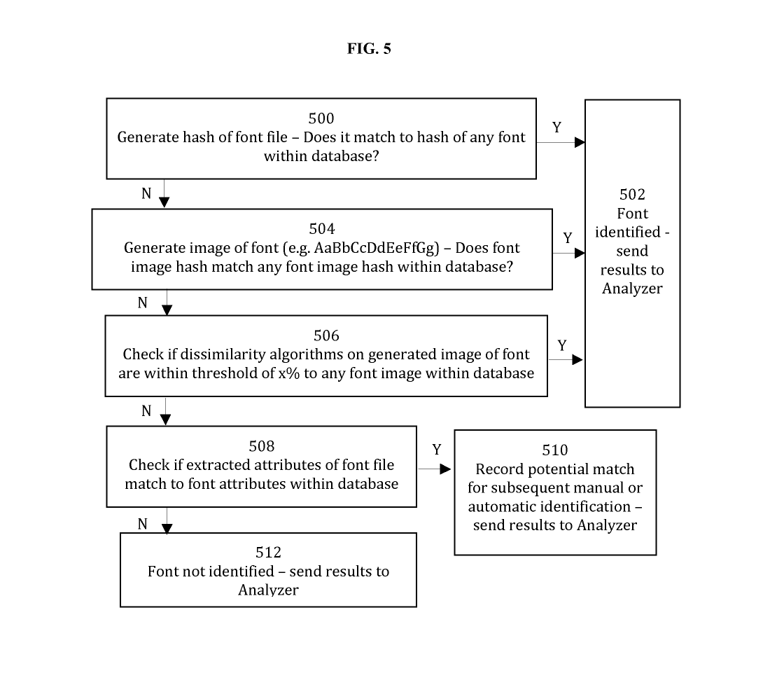

However, it should be noted that foundries often include metadata in their font files in an inconsistent way. Of the information above, almost all of the fields cannot be relied on to be present, therefore, the invention can use various means, including, but not limited to, a Font Identifier 108, License Recogizer 110, and Foundry Recognizer 112, the operation of which are explained in more detail with reference to FIGS. 5-7 below, to identify and generate more reliable information for any font attributes where possible, and populate the Font Database 114 with such font attributes (including, preferably, preview images of the font file as it would be rendered on a website). It should also be noted that one of the font attributes which can be extracted from a TTF and OTF font file, is known as a fstype string. The value associated with this attribute was meant to provide information regarding the permissions for use of the font according to the TTF and OTF specifications (for discussion of these specifications see https://en.wikipedia.org/wiki/TrueType and https://en.wikipedia.org/wiki/OpenType which are incorporated by reference) however, this attribute is not applied consistently and therefore currently has no informative value.

The next step 408 uses the Font Identifier 108 to compare and identify fonts, the operation of which is described below with reference to FIG. 5. At step 410 the Analyzer 106 determines whether the font is identified by the Font Identifier 108 is new (i.e. an unknown font on the Font Database 114), or not new (i.e. a known font on the Font Database 114). If the font is new, at step 412 the Analyzer creates a new font object in the Font Database 114 including a font ID and prepares to populate the Font Database 114 with font attributes that can be associated with the recorded observation of that font on the website 128. Using a font ID is the preferred embodiment, which is according to the common use in an object relational database, however, it will be apparent to those skilled in the art that other ways of uniquely identifying the font file can be used. Preferably a font ID If the font is not new at step 414, the Analyzer retrieves the font object and attributes already associated with that font and prepares to associate those font attributes with the recorded observation of that known font on the website 128.

At step 416 the License Recognizer 110 determines whether the use of the font is ‘unrestricted’ or ‘restricted’ and associates that attribute with the font. At step 418 the Foundry Recognizer determines the foundry (or copyright owner) name to be associated with the font object. Again, if the font was known, then this step is another ‘checking’ step. Alternatively, step 414 can proceed directly to step 420 if these ‘checking’ steps occur automatically, for example, the License Recognizer 110 and Foundry Recognizer 112 may be configured to query the Font Database 114 on a regular basis and update any attributes associated with known fonts as any new information is detected or inputted manually (in particular, when there are changes to license status as restricted or unrestricted and changes to font owners). At step 420, the observation of the font on the particular website 128 is recorded including the time and date of such observation, the website URL, the URL of the script or CSS file which refers to the font, the URI of the font and a record of the HTML and CSS files. Optionally, additional attributes can be recorded using third party information sources 116 (e.g. website registration information extracted from the WHOIS). Alternatively, such additional attributes can be recorded and associated with the font by the Report Generator 118 (discussed below) which can save bandwidth by limiting queries for additional information only about potential infringers listed in a report.

Identifying unknown font files is traditionally done by eye. Automated, reliable identification of fonts is a difficult problem. Cryptographic hashes can be used to uniquely identify files and create fingerprints for files. The use of a hash function means files can be compared without needing to inspect or store the contents of the files being compared. Preferably, the invention uses MD5 hash functions although alternative hash functions are suitable. e.g. for example, but not limited to SHA-1, CRC, MD4, MD6. The usual method of comparing arbitrary files with a hash such as MD5 is insufficient. If only a hash is used it will fail to match a significant number of fonts. A hash function is the method often employed to compare image files, movies, music files, etc. For example, software that promises to find duplicate images on your computer. In our preferred embodiment we create a hash of the font file as a means of comparison, but also create a hash of the font image as a means of comparison. FIG. 5 is a flow chart showing the preferred embodiment of how the Font Identifier 108 compares font files font images in order to identify whether a font file is known within the Font Database. Preferably, at step 500 the font is identified by generating a hash of the font file and determining whether it matches to the MD5 hash of a known font. If there is a match, the font is identified and the information forwarded to the Analyzer at step 502. If there is no match, at step 504 the Font Identifier 108 generates a preview image of the unknown font (e.g. AaBbCcDdEeFfGg), generates a hash for the preview image and determines whether it matches to the hash of an image of a known font. This is an identical rendering of the glyphs and the technique can reliably compare TFF and OTF files for the same font. If there is a match, the font is identified and the information forwarded to the Analyzer at step 502. If there is no match, at step 506, the Font Identifier uses dissimilarity algorithms, preferably, root-mean-square error (RMSE) to compare a preview image of the unknown font with images of known fonts, and will identify the unknown font if it is similar to a known font within a predetermined percentage (e.g. 99%) and the information will be forwarded to the Analyzer at step 502. It is acknowledged that this may increase the risk of ‘false positives’ but also may be used to identify potential font plagiarism. At step 508, other means of identifying the font will be used e.g attempting to match font attributes such as the name of the font file or the name of the font combined with the name of the designer. However, as this method is unreliable, preferably it can be used to provide supporting information during manual updating of unknown fonts and will not be used automatically for identification.

It will be apparent to those skilled in art that other means of automatically identifying fonts by using specific font attributes are possible. However, as such methods may be less reliable than comparing hashs or images, preferably, in step 510 the Font Identifier 108 should record the observation of a potential match and forward this to the Analyzer which can record potential matches in the Font Database. Preferably, a user 122 can be notified of potential font matches which can be manually confirmed by the user 122 and updated in the Font Database. Preferably, the Font Identifier will use this manually updated information to automatically identify any previously unknown fonts or potential matches in the Font Database. If a font is manually recognised, then all the other font files which are known to the be same will also be updated in the Font Database 114. Otherwise, if the font cannot be identified, at step 512 the font is determined as ‘unknown’ and this information forwarded to the Analyzer. Preferably, a unique hash will be associated with an unknown font (for example, generated from the font file and/or image). Therefore, if an unknown font is subsequently identified, whether automatically, or manually by a user 122 (or some combination of the two), the Font Identifier will update the Font Database 114 to identify fonts previously recorded as unknown in the same manner outlined in steps 500-512 above.

With regards to the dissimilarity algorithms used to match images of fonts in step 508, it will be apparent to those skilled in the art that other mathematical techniques may be used to compare images, including those listed below by way of example in Table 2 below:

TABLE 2

| | |
|---|---|
| AE | absolute error count, number of different pixels (-fuzz |
| | effected) |
| MAE | mean absolute error (normalized), average channel error |
| | distance |
| MEPP | mean error per pixel (normalized mean error, normalized |
| | peak error) |
| MSE | mean error squared, average of the channel error squared |
| NCC | normalized cross correlation |
| PAE | peak absolute (normalize peak absolute) |
| PSNR | peak signal to noise ratio. |

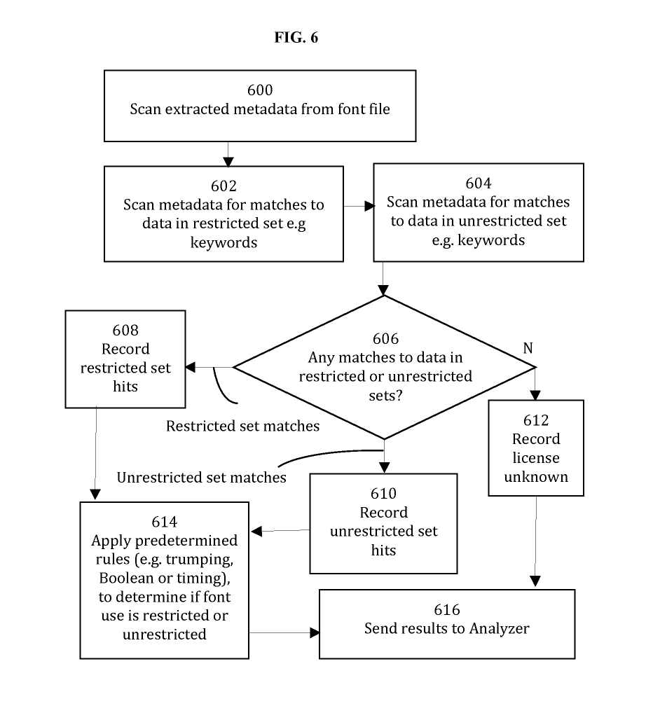

FIG. 6 is a flow chart showing the preferred embodiment of how the License Recognizer 110 detects whether usage of the font file is restricted or unrestricted. In the first step 600, the metadata from the font is extracted and scanned for matches to keywords within the restricted set in step 602 and the unrestricted set in step 604. It will be possible for a user 122 (with the required authority or access) to manually update the keywords and also specify various rules as to how they can determine if use of a font license is restricted or unrestricted (discussed below). Keywords belonging to the restricted set can be names of font copyright holders or foundries (and their website or license URLs) whose licenses do not allow linking to particular font files using the @font-face declaration. These names can match any field in the extracted metadata (e.g. designer=, fullname=, vender url=, designer url= manufacturer=). Some example keywords within the restricted and unrestricted sets are provided in Table 3 below.

TABLE 3
Example Keywords for License Recognizer

| Restricted Set | Unrestricted Set |
|---|---|
| ″SIL OPEN FONT LICENSE″, | ″http://www.linotype.com/license″, |
| ″http://www.gnu.org/licenses/lgpl.html″, | “DO NOT DISTRIBUTE WITHOUT |
| ″http://www.fsf.org/licenses/gpl.html″, | AUTHOR'S PERMISSION”, |
| ″GPL (General Public License)″, | “Do not distribute”, |
| ″GNU General Public License″, | “Do not copy”, |
| ″www.gnu.org″ | “http://www.adobe.com/type/legal.html”, |
| ″http://www.gnu.org/copyleft/gpl.html″, | “All adobe fonts are restricted”, |
| ″SIL Open Font License″, | “http://www.linotype.com/license”, |
| “Free to distribute” | “www.typography.com”, |
| “This font is freeware” | “http://www.typography.com/support/eul |
| ″copyleft″, | a.html”, |
| ″Free License (La Tipomatika)″, | “http://dharmatype.com”, |
| ″ParaType Free Font License″, | “Hoefler & Frere-Jones”, |
| “LaTeX Project Public License”, | “émigré”, |
| “MGOpen”, | “Adobe”, |
| “Magenta Ltd”, | “Dalton Magg”, |
| “gnome foundation”, | “Aller”, |
| “Allerta″, | “anatoletype”, |
| ″Beteckna″, | “Ascender Corporation”, |
| ″Bitstream Vera″ | “Schwartzco Inc” |

The content of these sets are not exhaustive and will be much larger when used by the License Recognizer 110 in practice. It will be apparent to those skilled in the art that it also possible to use regular expressions (in addition to ‘keywords’) to recognize ‘unrestricted’ or ‘restricted’ licenses. The use of regular expressions to identify font foundries is discussed in Table 4 below. At step 606 the License Recognizer determines whether there are any matches to the restricted set 602 and will record those matches at step 608 and if there are matches to the unrestricted set 604 it will record them at 610. If there are no matches, it will record this at step 612. At step 616, the License Recognizer 110 will send the license attribute unrestricted, restricted, or unknown respectively, to the Analyzer 106.

Preferably, the detection of an unrestricted keyword will trump a restricted keyword. This is because a font foundry will often release free fonts, despite its license not allowing @font-face linking in general. The name of the free font can be in the unrestricted set 604 while the foundry name can remain on the restricted set 602. With regard to determining whether font use is infringing, it should be noted that according to the current preferred embodiment, the Scanner 100 is configured to only detect and prepare a list of font links 126 comprising OTF and TTF font file types although it will be readily apparent to those skilled in the art that searching for other font file types can be supported. This is because this particular type of font file does not currently support DRM, therefore, unless that font is available under an unrestricted license (e.g. free to distribute), it is unlikely that a restricted license of the font copyright owner (e.g. font foundry) will allow @font-face declaration links, and therefore use of restricted OTF or TTF fonts is likely to be infringing use. It should also be noted that the ‘unrestricted’ license of many fonts do not allow linking via @font-face, or only allow linking with attribution notice displayed on the linking website. Therefore, the use of many free fonts should properly be identified as ‘restricted’ although their font metadata may contain ‘unrestricted’ keywords (for example, the Scanner can scan the HTML of a website to detect whether an attribution notice has been included as discussed in this specification below). Therefore, the License Recognizer 110, Analyzer 106 and Font Database 114 can be configured to ensure certain keywords will always result in a ‘restricted’ identification of license (for example, the foundry name or font name of a free font which does not allow @font-face linking used as special ‘restricted trumping’ keywords) contrary to the usual rule that ‘unrestricted’ keywords will trump ‘restricted’ keywords. In the preferred embodiment the trumping rules use the presence of combinations of certain keywords (e.g. Boolean operators) and wildcards within keywords as well as regular expressions are used in order to enable the License Recognizer 110 to detect whether the use of the font is ‘restricted’ or ‘unrestricted’. Alternative trumping rules will be apparent to those skilled in the art. For example, the License Recognizer 110 may use other forms of data to determine and record if use of a font is ‘restricted’ (e.g. often licenses for free fonts will require attribution to the font creator to be visible on the website 128. The License Recognizer can check with Scanner to determine whether the HTML of the website 128 includes such attribution). Preferably, the list of keywords available to the License Recognizer 110 may be updated automatically or manually by a user 122 and may be subject to certain timing rules, for example, they might be unrestricted or restricted between certain time periods (e.g. a font identified by its font name may be released into the public domain for a certain period or a foundry may change their license on a certain date so various fonts become restricted or vice versa). Preferably, at step 614, the hits recorded in the restricted set at step 608 and hits recorded in the unrestricted set 610 will be analyzed according to the aforesaid ‘trumping’, Boolean, and ‘timing’ rules to determine whether the use of the font is ‘restricted’ or unrestricted′. For the avoidance of doubt, a similar use of rules may apply to the operation of the algorithms for the Font Identifier 108 and Foundry Recognizer 112.

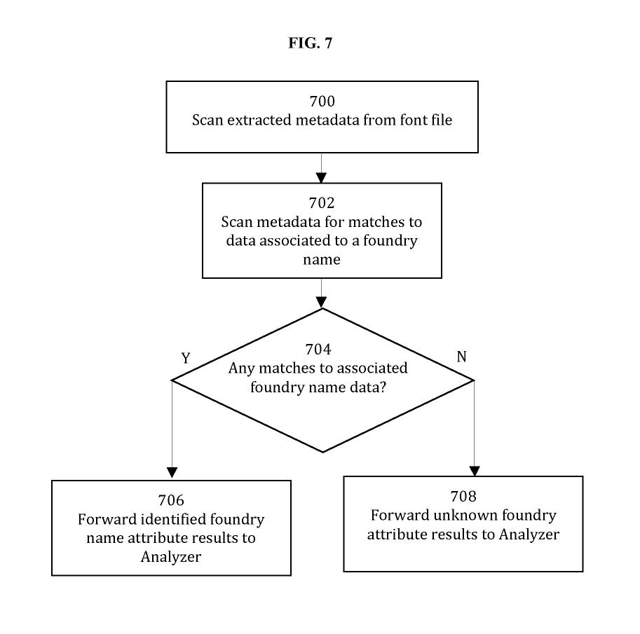

FIG. 7 is a flow chart showing the preferred embodiment of how the Foundry Recognizer 112 determines who is the font copyright holder or foundry. At step 700, the metadata is extracted from the font file. At step 702 the metadata is scanned for predetermined data (e.g. keywords) which are associated with a particular foundry name. Table 4 below provides an example list of such foundry associated keywords and regular expressions. In computing, a regular expression provides a concise and flexible means to “match” to specify and recognize strings of text, such as particular characters, words, or patterns of characters. In the table below, examples of regular expressions or strings are shown bounded by “forward slashes”. Preferably, a plurality of keywords or regular expressions can used to match to a particular foundry name.

TABLE 4
Foundry Associated Keywords

| Foundry Name | Associated Keywords |
|---|---|
| Broderbund | /copyright=[\hat{ }=]*Br.*derbundSoftware/ |
| dot colon | ″http://www.dotcolon.net” |
| Magenta Ltd | ″http://www.magenta.gr″ |
| 251 Dutch Design | ″copyright=251 Dutch Design″ |
| Adobe | “Copyright (c) 1988, 1990, 1993 Adobe Systems”, |
| | “Adobe” |
| Bitstream | /copyright=[\hat{ }=]*Bitstream Inc/ |

At step 704, it is determined whether there is data present in the font metadata which associate with a foundry name. If so, at step 706, the foundry name associated with the font is forwarded to the Analyzer 106. If not, at step 708, the attribute ‘unknown foundry’ is forwarded to the Analyzer. As discussed in relation to the License Recognizer 110 above, it will be apparent to those skilled in the art that such keywords or regular expressions can utilize certain rules and operators that must apply before being matched to a foundry name.

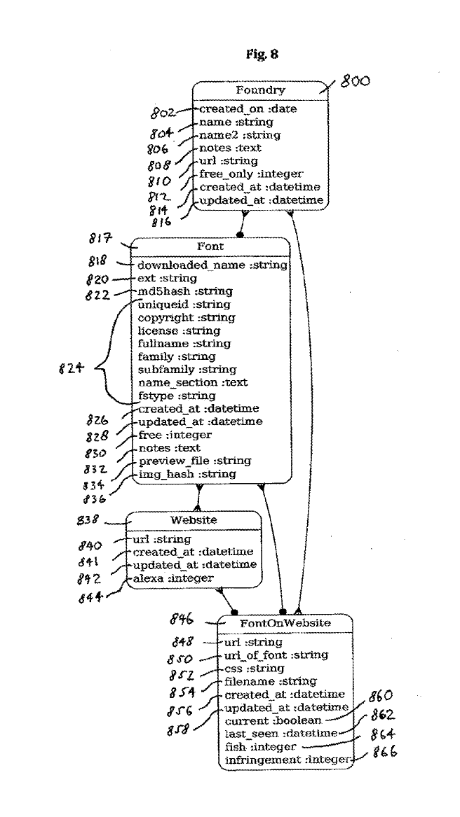

FIG. 8 is a schematic showing the preferred embodiment of the model for the Font Database 114. Preferably the invention has been implemented using the Ruby on Rails programming language. The Font Database can be implemented on any computer-readable storage medium which can be accessed via a computer network. The boxes in the schematic represent objects, namely, columns within the Font Database 114 and the contents of those columns are rows within the database. The symbols on the lines between the boxes represent the relationship of the objects in the Font Database 114, being the columns and their rows (e.g. ball symbol linking to the branch symbol represents one to many relationship, branch symbol linking to branch symbol represents many to many relationship). The first box 800 is the foundry object column. Within that column are the following rows: 802 for recording the date of creation of the foundry object, 804 for recording the foundry name, 806 for recording an alternative foundry name (optional), 808 for recording notes associated with that foundry, 810 for recording the URL of the foundry website, 812 for recording whether the foundry allows restricted or unrestricted or unknown use of fonts, and rows 814 and 816 for recording the date and time the foundry object was created and updated in the Font Database 114. The second box 817 is the font object column. Within that column are the following rows: 818 is the unique filename used to temporarily store the downloaded font file, 820 for recording the font file extension (e.g. .otf, .ttf), 822 for recording the hash of the font file, 824 for recording the various font attributes that can be extracted from the NAME table of the metadata of a font file (referred to in the discussion of FIG. 4 above), 826 and 828 for recording the date and time the font object was created and updated in the Font Database 114, 830 for recording whether use of the font is restricted, unrestricted or unknown, 832 for recording notes associated with that font, 834 for recording the preview image of the font and 836 for recording the hash created for such preview image. The third box 838 is the website object column. Within that column are the following rows: 840 for recording the URL of the website, 841 and 842 for recording the date and time the website object was created and updated in the Font Database 114, and 844 for recording the Alexa.com ranking of the website (as discussed above, other attributes regarding the website may be recorded such as the website owner and their financial status). The fourth box 846 is the FontOnWebsite object column. Within that column are the following rows, 848 for recording the URL of the website, 850 for recording the URL of the linked font to be downloaded, 852 for recording the URL to the CSS of the font file, 854 for recording the name of the downloaded font file, 856 and 858 for recording the date and time the FontOnWebsite object was created and updated in the Font Database 114, 860 for recording whether the font is currently used by the website, 862 for recording the date and time the website 128 was last checked for the presence of this font, 864 for recording whether the website owner is worth pursuing having regard to their financial status (which can be determined manually but preferably automatically by accessing third party information sources 116) and 866 for recording whether the use of the font on the website 128 is infringing (which can also be done manually by a user 122 or automatically).

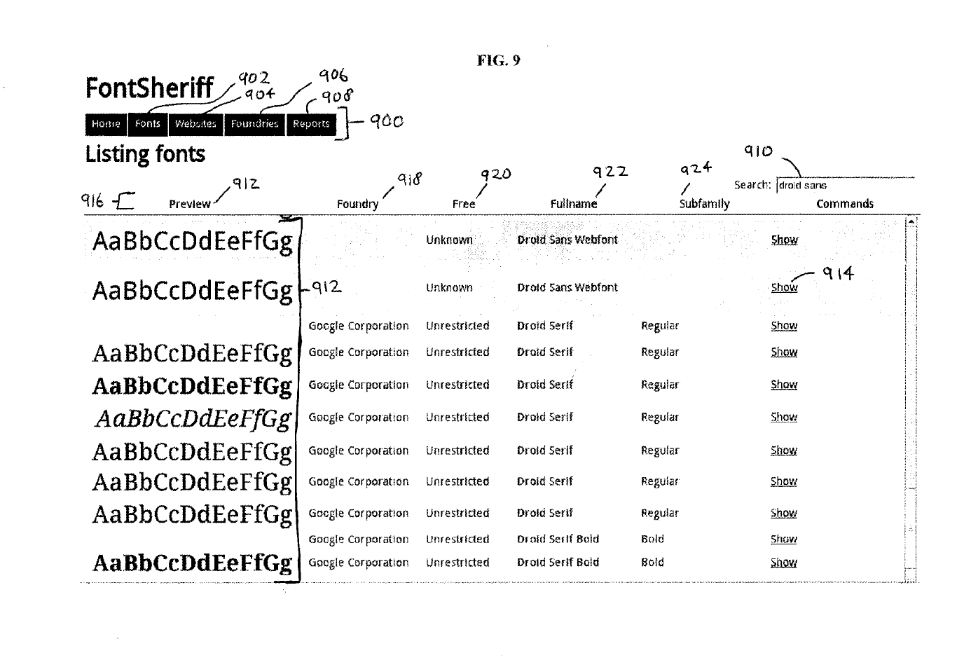

As shown in FIG. 1, the Font Database 114 is connected to all the other components of the invention and can be configured to be populated automatically by those components or manually by the user 122. The user 122 can also search the Font Database manually using keyword searches. FIG. 9 is a screen shot of the preferred embodiment of the graphical user interface (GUI) of the Font Database which is hosted on a secure server and can be accessed online via a web browser. A user 122 can use the tabs 900 to select what aspect of the database they wish to search e.g. fonts 902, websites 904, foundries 906, or reports 908. A search box 910 is provided to facilitate searching the aspects of the database. The screenshot shows the view available under the fonts tab which includes a list of fonts recorded on the Font Database and image previews 912 of the font files. In the preferred embodiment, the image previews 912 are a sample of a set of glyphs that are representative of the font e.g. ‘AaBbCcDdEeFfGg’. Another alternative example is a list of characters in a sentence. By clicking a ‘show’ link 914, a user can drill down into the database to view all information associated with a particular font including websites which the font is linked to and to visit those websites via an anonymous proxy server for the purposes of disguising the referring website from the website hosting a font. It is also possible to view all attributes associated with the fonts including the raw metadata extracted from the font file. Preferably, the most important attributes associated with the individual font files are shown in separate columns 916 to a user. A user can also configure the GUI to rank the fonts according to what is most important to a user (e.g. alphabetically, number of hits, foundry, font, financial status of website owner etc). By way of example, in this particular screenshot, the Foundry Recognizer has not identified the foundry of the scanned fonts in the Foundry column 918 as Google Corporation, the License Recognizer has determined that the license of the scanned fonts are ‘Unrestricted’ and “Unknown” in the Free column 920, and the Font Identifier has identified the name of the scanned font in the Fullname column 922 and the name of the sub family of the scanned font in the Subfamily column 924. Preferably, newly scanned fonts are listed as ‘not yet identified’ by default.

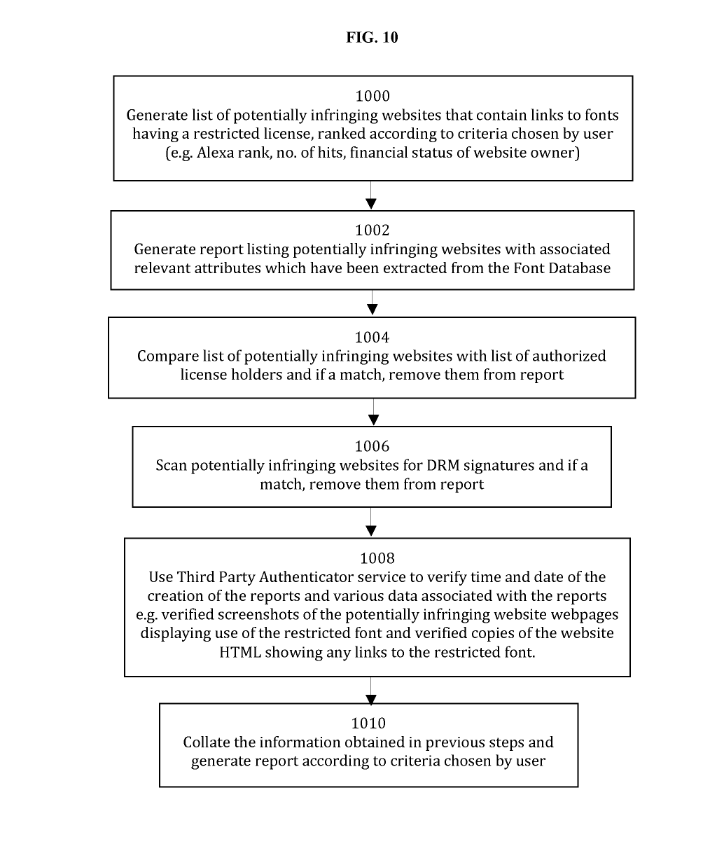

FIG. 10 is a flow chart showing the preferred embodiment of how the Report Generator 118 creates lists of potentially infringing websites. In the preferred embodiment this can be accessed by a user via the report tab 908. At step 1000, the Report Generator 118 creates a list of potentially infringing websites from information within the Font Database 114 in a manner similar to ranking of the list generator 102, discussed above, but with the difference that a user 122 can specify by which criteria to rank potential infringing websites e.g. Alexa ranking, number of website hits, and/or financial status of website owner. At step 1002, the report provides the list of potentially infringing websites with associated relevant attributes which have been extracted from the Font Database 114. Preferably, the website owner of the potentially infringing website will also be recorded along with any investigative notes in a free form text field.

It should be noted that the according to the present embodiment of the invention, it is assumed that linking to a ‘restricted’ font is not authorized by the font copyright owner, although that may not be the case. The invention may utilize various means in order to reduce any ‘false positives’ that may occur. For example, the font copyright owner can provide a list of names of authorized license holders. Preferably, at step 1004, the list of potential infringers may be compared to the names of authorized license holders (and their assignees) and any matching the latter are removed from the report. There are other methods that may be used in order to determine if linking to a font on a website 128 is authorized. For example, some font distribution services (e.g. Typekit) allow linking to fonts by ensuring such linking occurs via certain servers or use certain code incorporated into the HTML or CSS of the website 128 to implement DRM. It will be apparent to those in the art that various methods may be implemented by the invention to detect whether the font is being used in an authorized manner (e.g. whether the website uses DRM methods that have been approved by a foundry). Preferably, at step 1006 the HTML of websites of potential infringers are checked for ‘signatures’ indicating the use of DRM methods, for example, but not limited to, checking for the presence of certain code or font files in a format allowing DRM (such as EOT or WOFF) with the font having the same name as the ‘infringing’ link, checking whether the @font-face link is to a ‘safe’ server that implements DRM (e.g only allows access of a certain number of downloads to certain websites having valid licenses) or checking for the presence of certain scripts or code within the website HTML. It should be noted that such “DRM checking” may be implemented in advance by the Scanner 100 to ensure that only potentially infringing links to fonts are downloaded as part of the steps 300-314 outlined in FIG. 3 above and reduce the amount of false positives.

It is also important to ensure that reports generated by the invention are reliable from an evidentiary standpoint, e.g. in the event that they are used in a copyright infringement lawsuit. Preferably, at step 1008, the Report Generator 118 uses a Third Party Authenticator 120 to verify time and date of the creation of the reports and various data associated with the reports e.g. verified screenshots of the potentially infringing website webpages displaying the restricted font and verified copies of the HTML of the website 128 showing any links to the restricted font. The involvement of the Third Party Authenticator 120 in the preferred embodiment of the invention is discussed above with reference to FIG. 1. In the absence of such third party authentication services (as such services usually require a fee) the Report Generator can use the Scanner 100 to obtain such information direct from the websites 128. The Report Generator can be configured so that such information is forwarded to an independent server which can be used as evidence of the time and date the information was sent (e.g. to a Gmail account) which can be useful for evidential purposes. Preferably, the Report Generator will also be configured to highlight the portion of a screenshot of a webpage showing use of the infringing font as well as tagging its name and the time/date information associated with the its duration of use (e.g. by putting a highlighted box around the font on the screenshot). In step 1010 the Report Generator will collate the information obtained in steps 1000-1008, and present it to the user 122 in an electronic or paper report (according to criteria selected by the User 122). Various methods of configuring the presentation of information in such report so it will be useful to a user 122 will be apparent to those in the art, whether by way of text, lists, charts, graphs, and diagrams or some combination of the aforesaid. Preferably, the generation of a report is interactive, whereby a user can create their own filters, sorting, and exporting to a spreadsheet (e.g. XLS). The information generated by the Report Generator 118 may also be integrated directly into a user's own database, computer network, or systems and/or provided to them via various communication channels such as by cell phone text, or other wireless communication. Alternatively, the GUI and dashboard of a website hosting information on the Font Database 114 (as exemplified with reference to FIG. 9 above) can include this information. The information provided to a User 122 by the invention can be configured so that a user 122 may have preliminary reports sent to them of new potential infringers, such preliminary reports not containing full information which will allow identification of such potential infringers, whereby the user 122 not be able to access the full report (until payment of a fee or when some other condition is fulfilled). Alternatively, the user 122 may have full or limited access to the Font Database 114, or may have access to periodic reports for a subscription fee. Thus the invention as described herein allows the detection and monitoring of potentially infringing fonts on the Internet, and allows the generation of reports that font copyright owners can use to enforce their intellectual property rights.

In an alternative embodiment, it will be apparent to those skilled in the art, that while the majority of the specification below will refer to the scanning of website HTML, the same principles can apply the scanning of font images in multimedia content 130 in order to identify fonts which can be matched to known attributes about such fonts on a Font Database 114. Therefore, reference to ‘websites’ 128 in this specification can be interchanged with ‘multimedia content’ 130 and reference to downloading of ‘font files’ can be interchanged with downloading of ‘font images’ (preferably images of individual font letters), but with font images the only metadata extracted will be the font image itself and the Scanner 100 can be configured to include attributes such as the location (e.g. URL, file name) and the time/date it was scanned. Multimedia content 130 includes, but is not limited to digital and hardcopy publications, website content (including images and videos), newspapers, magazines, and files capable of displaying fonts such .PDFs and .TIFFs and any printed material containing font images. PDFs can contain full fonts or a subset of font files (i.e. individual letters of a particular font). Comparing subsets of fonts to known fonts on files can be achieved by comparing image hashes of individual letters. Preferably, the Scanner 100 will search through websites 128, downloading PDF files and investigating them for embedded fonts. Additionally, Adobe Flash files can be scanned for whether they contain fonts.

FIG. 11 is a flow chart showing an alternative embodiment of how the font Analyzer 106 downloads, extracts, identifies and records the font image metadata from multimedia content on the Font Database. At step 1100, the Scanner 100 scans multimedia content 130 using algorithms for 2-D object recognition, apparent to those skilled in the art of computer vision (for example algorithms referred to in the following articles incorporated by reference: www.tina-vision.net/docs/memos/1996-003.pdf and www.iaeng.org/IJCS/issues_v36/issue_{—}1/IJCS_{—}36_{—}1_{—}05.pdf) and extracts font images and associated attributes associated with such multimedia content e.g. time/date, URL, file name, source of multimedia content. The multimedia content may be located from a variety of sources. For example, the Scanner may be configured to search the Internet for website content (excluding HTML) and files which may contain font images. In addition, files may be directly provided to Scanner 100 (e.g. by physically scanning printed material and transmitting the file to the Scanner 100 or otherwise providing the Scanner 100 with data that may contain font images. At step 1102, the font identifier 108 is used to identify the font (refer to FIG. 12 below). At step 1104, it is determined whether the font is new to the database or not. If the font is new, at step 1106, a new font object is created in the Font Database 114 and a new font ID is generated. If the font is known, at step 1108, the font object and additional attributes associated with font including foundry name and license information are retrieved from the Font Database 114. At step, 1110, the observation of font on the Multimedia Content 130 including attributes (e.g. time/date of observation, URL, file name, source of multimedia content) is recorded in the Font Database 114.

FIG. 12 is a flow chart showing an alternative embodiment of how the Scanner 100 extracts and Font Identifier 108 compare font files font images extracted from multimedia content in order to identify whether a font file is known within the Font Database. In step 1200, font images and associated multimedia content attributes are received from the Analyzer. In step 1202, a hash of the image of individual font letters is created and it is determined whether the hash of the unknown font image matches the hash of any font image of known individual font letters within font database. If so, in step 1204, the font is identified and the results sent to the Analyzer 106. At step 1206 dissimilarity algorithms are used on generated image of font to check if they are within a certain threshold (e.g. 99%) to any font image within the Font Database 114. It is acknowledged that this may increase the risk of ‘false positives’ but also may be used to identify potential font plagiarism. If so, the font is identified and the results sent to the Analyzer in step 1204. If not, at step 1208, it is checked if attributes associated with font image match to font attributes within database (e.g. source of multimedia content with name of font foundry or name of license holders). At step 1210, a potential match for subsequent manual or automatic identification is recorded and the results sent to Analyzer. However, as this method is unreliable, preferably it can be used to provide supporting information during manual updating of unknown fonts and will not be used automatically for identification. It will be apparent to those skilled in art that other means of automatically identifying fonts by using specific font attributes are possible as discussed with reference to FIG. 5 above. Manual or automatic updating of the Font Database 114 is also anticipated, as discussed with reference to FIG. 5 above. It is anticipated that a list of font images and associated attributes may be provided by a font foundry to populate the Font Database 114 (whether uploaded directly or indirectly) which will assist with the identification of font images extracted from multimedia content 130. Therefore, the Font Database 114 will be configured to include information regarding the monitoring of font usage on websites, but on multimedia content generally.

While the invention has been illustrated and described in detail in the foregoing description, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practicing the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A method of monitoring font usage including the steps of:
searching multimedia content for a font represented by a font image or font file;
extracting metadata from said font image or font file to populate a database;
comparing said metadata with information within said database to identify said font.

2. The method of claim 1, further including the steps of:
searching the HTML and associated files of a website for a linked font file;
using identification means to identify a font from said linked font file;
using information extraction means to extract a plurality of attributes from said linked font file;
using comparison means on said attributes with information in said database to detect whether usage of said font file has been authorized according to the license of a font copyright owner.

3. The method of claim 1, further including the steps of:
searching the HTML files of a plurality of websites;
identifying all style content including Cascading Style Sheet (CSS) files and HTML STYLE tags;
identifying all script content including external scripts and HTML SCRIPT tags;
searching all said files, scripts and tags for the presence of an @font-face CSS declaration;
upon identifying a said @font-face CSS declaration within said website, extracting and recording the URL location of the link to the font file and downloading the font file;
identifying whether said font file is already known by using comparison means to compare it to a plurality of attributes of previously recorded font files within a database;
wherein if said font file is determined as known by using comparison means then recording and updating said attributes including the time and date of the detection of link to said known font file on said web page within said database;
wherein if said font file is determined as unknown by using comparison means then recording it as a newly identified font file and using information extraction means including comparison with known keywords to extract a plurality of attributes from metadata of said newly identified font file including the font name, the font copyright owner, font license information, and whether said font license permits linking using said @font-face CSS declaration, and recording said attributes and the time and date of the detection of link to said newly identified font file on said web page within said database.

4. The method of claim 2 wherein said information extraction means is configured to use comparisons with known keywords to extract said attributes from said metadata of said font files.

5. The method of claim 3 wherein said comparison means is configured to identify said unknown font file by using a hash of said unknown font file to determine whether it is the same as the hash of a said known font file.

6. The method of claim 3 wherein said comparison means is configured to identify said unknown font file by generating an image preview of an unknown font file and comparing the hash of the resulting image with hashes of images of known font files, and if the hashes of images are identical then identifying said unknown font file as said known font file having the identical hash.

7. The method of claim 3 wherein said comparison means is configured to use a dissimilarity algorithm including using the normalized root mean squared method to compare said image preview of an unknown font file with images of said known font files and if a known image is similar to said image preview within a predetermined threshold value, then identifying said unknown font file as said known font file having a similar known image.

8. The method of claim 3 wherein said linking to said font file using said @font-face CSS declaration is identified and recorded as restricted or unrestricted within said database using license recognizer means including determining whether said plurality of attributes extracted from metadata contain features such as keywords or data indicative of a restricted or unrestricted license for that particular font file.

9. The method of claim 1 wherein said database is configured to generate reports including websites ranked according the estimated number of downloads of restricted font files, time and date of such downloads, and financial status of the website owner.

10. A system for monitoring font usage comprising:
a scanner configured to scan the HTML files of a plurality of websites, identify all style content including Cascading Style Sheet (CSS) files and HTML STYLE tags, identify all script content including external scripts and HTML SCRIPT tags, search all said files, scripts and tags for the presence of an @font-face CSS declaration and upon identifying a said @font-face CSS declaration within said website, extract and record the URI location of the font file;
a database configured to record a plurality of attributes related to a plurality of font files and their use on a plurality of websites;
an analyser configured to download the font file, identify whether said font file is already known by using comparison means to compare it with a plurality of attributes of previously recorded font files within said database;
wherein if said font file is determined as known by using comparison means then recording and updating said attributes including the time and date of the detection of link to said known font file on said web page within said database;
wherein if said font file is determined as unknown by using comparison means then recording it as a newly identified font file and using information extraction means including comparison with known keywords to extract and record a plurality of attributes from metadata of said newly identified font file including the font name, the font copyright owner, font license information, and whether said font license permits linking using said @font-face CSS declaration, and recording said attributes and time and date of the detection of link to said newly identified font file on said web page within said database.

11. The system of claim 10 wherein said comparison means is configured to identify said unknown font file by using a hash of said unknown font file to determine whether it is the same as the hash of a said known font file.

12. The system of claim 10 wherein said comparison means is configured to identify said unknown font file by generating an image preview of an unknown font file and comparing the hash of the resulting image with hashes of images of known font files, and if the hashes of images are identical then identifying said unknown font file as said known font file having the identical hash.

13. The system of claim 10 wherein said comparison means is configured to use a dissimilarity algorithm including using the normalized root mean squared method to compare said image preview of an unknown font file with images of said known font files and if a known image is similar to said image preview within a predetermined threshold value, then identifying said unknown font file as said known font file having a similar known image.

14. The system of claim 10 wherein said linking to said font file using said @font-face CSS declaration is identified and recorded as restricted or unrestricted within said database using license recognizer means including determining whether said plurality of attributes extracted from metadata contain features such as keywords or data indicative of a restricted or unrestricted license for that particular font file.

15. The method of claim 10 wherein said database is configured to generate reports including websites ranked according the estimated number of downloads of restricted font files, time and date of such downloads, and financial status of the website owner.
